(19) United States
(12) Patent Application Publication
(10) Pub. No.: US 2019/0244723 A1
(43) Pub. Date: Aug. 8, 2019

(54) COMPOSITE TWISTED WIRE

(71) Applicant: NISSHIN STEEL CO., LTD., Tokyo (JP)

(72) Inventors: Shinichi KAMOSHIDA, Osaka (JP); Tadaaki MIONO, Osaka (JP); Yasunori HATTORI, Osaka (JP)

(73) Assignee: NISSHIN STEEL CO., LTD., Tokyo (JP)

(21) Appl. No.: 16/388,077

(22) Filed: Apr. 18, 2019

Related U.S. Application Data
(62) Division of application No. 15/105,036, filed on Jun. 16, 2016.

(30) Foreign Application Priority Data
Dec. 17, 2013 (JP) 2013-260697
Mar. 28, 2014 (JP) 2014-070616

(51) Int. Cl. H01B 5/10; D07B 1/14

(52) U.S. Cl. CPC H01B 5/104; D07B 1/147; D07B 2205/306; H01B 7/0009; D07B 2201/2036; D07B 2201/2011; D07B 2201/2065

(57) ABSTRACT

A composite twisted wire (1) which is obtained by twisting a plurality of strands. This composite twisted wire (1) includes: an aluminum-covered strand (2) that is obtained by forming a coating film (2b), which is formed of aluminum or an aluminum alloy, on the surface of a steel wire (2a); and an aluminum wire (3) that is formed of aluminum or an aluminum alloy. This composite twisted wire is reduced in weight, while exhibiting excellent tensile strength and excellent long-term stability with respect to electrical resistance. Consequently, this composite twisted wire is suitable, for example, for use as a wire harness of automobiles.

### TECHNICAL FIELD

The present invention relates to a composite twisted wire. More specifically, the present invention relates to, for example, a composite twisted wire which can be suitably used in a wire harness of an automobile, and the like.

### BACKGROUND ART

A copper wire has hitherto been used as an electric wire which is used in a wire harness of an automobile, and the like. However, in recent years, since reduction of weight has been required for an electric wire, it has been desired to develop an electric wire in which a metal wire having a weight lower than a copper wire is used. As a metal wire having a weight lower than the copper wire, it has been thought to use a wire made of aluminum or an aluminum alloy. The wire made of aluminum or an aluminum alloy has a weight lower than the copper wire. However, the wire does not have a tensile strength necessary for an electric wire because the wire is poor in tensile strength. Therefore, there has been proposed a composite electric wire having improved tensile strength and improved electric conductivity, which includes a wire made of stainless steel having excellent tensile strength and a wire made of aluminum or an aluminum alloy in an electric wire. As the above-mentioned composite electric wire, there has been proposed an electric wire in which a wire made of, for example, copper, a copper alloy, aluminum, an aluminum alloy or the like is used as a first wire, and a wire made of stainless steel is used as a second wire (see, for example, claims 1 to 3 of Patent Document 1).

### PRIOR ART LITERATURES

### Patent Document

Patent Document 1: Pamphlet of WO 2005/024851 A1

### SUMMARY OF THE INVENTION

### Problem to be Solved by the Present Invention

The above-mentioned electric wire however has the following problems: As an electric wire having a decreased diameter and a reduced weight, an electric wire in which a wire made of stainless steel and a wire made of aluminum or an aluminum alloy are used in combination has been proposed in Patent Document 1. When the electric wire is attached to a terminal, the terminal is crimped, and then a tensile test of the terminal is carried out, the above-mentioned electric wire has a disadvantage such that the wire made of aluminum or an aluminum alloy which is used in the electric wire is broken at a crimping portion under a low tensile load. In addition, when the wire made of aluminum or an aluminum alloy is broken at the crimping portion, the wire made of stainless steel is drawn out from the electric wire at the crimping portion. Therefore, there is a possibility that reinforcing effect based on the wire made of stainless steel is not sufficiently exhibited.

When the above-mentioned electric wire was attached to a terminal, the terminal was crimped, and a cross-section of the crimp at the crimping portion was observed, it was observed that the wire made of aluminum or an aluminum alloy was greatly deformed at the crimping portion, and the area of the cross-section of the wire made of aluminum or an aluminum alloy became smaller because the wire made of aluminum or an aluminum alloy is softer than the wire made of stainless steel, and that the shape of the wire made of stainless steel has been maintained. From this fact, when a tensile test of the above-mentioned electric wire is carried out, the wire made of aluminum or an aluminum alloy is broken at the crimping portion where the area of the cross-section becomes smaller due to crimping of the electric wire with a terminal, and the wire made of stainless steel maintains its shape without braking. Therefore, the wire made of aluminum or an aluminum alloy cannot firmly hold the wire made of stainless steel, and only the wire made of stainless steel is drawn out from the electric wire at the crimping portion. Thereby, it is thought that tensile strength of the electric wire cannot be improved.

When an electric wire is attached to a terminal, and the terminal is crimped in order to avoid that only the wire made of stainless steel is drown out from the electric wire at the crimping portion, it has been proposed to increase a pressing amount in crimping a terminal. When the pressing amount is increased in crimping the terminal, the area of the cross-section of the wire made of aluminum or an aluminum alloy at the crimping portion is furthermore decreased, and the wire made of aluminum or an aluminum alloy is broken by a weaker tensile stress. Therefore, the tensile strength of the electric wire cannot be increased only by increasing the pressing amount in crimping the terminal.

Furthermore, in the electric wire in which a wire made of stainless steel and a wire made of aluminum or an aluminum alloy are used in combination, since the stainless steel used in the electric wire is different in kind of a metal from the wire made of aluminum or an aluminum alloy used in the electric wire, there is a possibility that corrosion based on potential difference occurs at the contact portion of the stainless steel and the aluminum or aluminum alloy. In the electric wires disclosed in Patent Document 1, an electric wire in which a combination of stainless steel and copper is employed solves a problem of corrosion based on potential difference. However, an electric wire in which a combination of stainless steel and an aluminum alloy is employed does not solve this problem.

The present invention has been made in view of the above-mentioned prior art. An object of the present invention is to provide a composite twisted wire which has a light weight, and is excellent in tensile strength and temporal stability of electric resistance.

### Means for Solving Problem

The present invention relates to:

(1) a composite twisted wire in which plural wires are twisted, comprising an aluminum-covered wire in which a layer of aluminum or an aluminum alloy is formed on the surface of a steel wire, and an aluminum wire made of aluminum or an aluminum alloy,
(2) the composite twisted wire according to the above-mentioned item (1), wherein the steel of the steel wire used in the aluminum-covered wire is carbon steel or stainless steel,
(3) the composite twisted wire according to the above-mentioned item (1) or
(2), wherein all of the wires positioning at the outermost surface of the composite twisted wire are the aluminum wires, and
(4) the composite twisted wire according to any one of the above-mentioned items (1) to (3), wherein the aluminum-covered wire is contacted only with the aluminum wire.

### Effect of the Invention

According to the present invention, there is provided a composite twisted wire which has a light weight, and is excellent in tensile strength and temporal stability of electric resistance.

### BRIEF DESCRIPTION OF DRAWINGS

FIG. 1 is a schematic cross-sectional drawing which shows one embodiment of a composite twisted wire of the present invention.

FIG. 2 is a schematic cross-sectional drawing of an aluminum-covered wire which is used in the composite twisted wire of the present invention.

FIG. 3 is a schematic explanation view which shows one embodiment of a process for producing a composite twisted wire of the present invention.

Each of FIG. 4(a) to FIG. 4(i) is a schematic cross-sectional drawing which shows other embodiment of a composite twisted wire of the present invention, respectively.

FIG. 5 is a graph which shows increased amount of electric resistance of the composite twisted wires or twisted wires obtained in Example 34 of the present invention, Comparative Example 6, Comparative Example 7 and Comparative Example 8 with the passage of time.

FIG. 6 is an optical microscope photograph of a cross-section of a crimping portion of a terminal and a composite twisted wire obtained in Comparative Example 7.

FIG. 7 is an optical microscope photograph of a cross-section of a crimping portion of a terminal and a composite twisted wire obtained in Example 34 of the present invention.

### MODE(S) FOR CARRYING OUT THE INVENTION

As described above, the composite twisted wire of the present invention is a composite twisted wire in which plural wires are twisted, and which includes an aluminum-covered wire in which a layer of aluminum or an aluminum alloy is formed on the surface of a steel wire, and an aluminum wire made of aluminum or an aluminum alloy.

In the composite twisted wire of the present invention, as described above, an aluminum-covered wire in which a layer of aluminum or an aluminum alloy is formed on the surface of a steel wire, and an aluminum wire made of aluminum or an aluminum alloy is used, and the aluminum-covered wire and the aluminum wire are twisted. The steel wire used in the aluminum-covered wire has a deformation resistance higher than the aluminum wire. Therefore, when the composite twisted wire is attached to, for example, a crimp terminal, and the composite twisted wire is crimped with a crimp terminal, the aluminum-covered wire included in the composite twisted wire is hardly drawn out from the composite twisted wire at the crimping portion, and a high tensile strength is imparted to the composite twisted wire. Moreover, the composite twisted wire is excellent in temporal stability of electric resistance.

In addition, in the composite twisted wire of the present invention, the aluminum-covered wire in which a layer of aluminum or an aluminum alloy is formed on the surface of a steel wire and the aluminum wire made of aluminum or an aluminum alloy are used, and the surface of the aluminum-covered wire is homogeneous to the surface of the aluminum wire. Therefore, corrosion based on potential difference due to the contact of heterogeneous metals can be suppressed.

Accordingly, when the composite twisted wire of the present invention is connected to a terminal, reliability of the terminal can be improved.

Hereinafter, the composite twisted wire of the present invention will be described with reference to drawings. However, the present invention is not limited only to the embodiments described in the drawings.

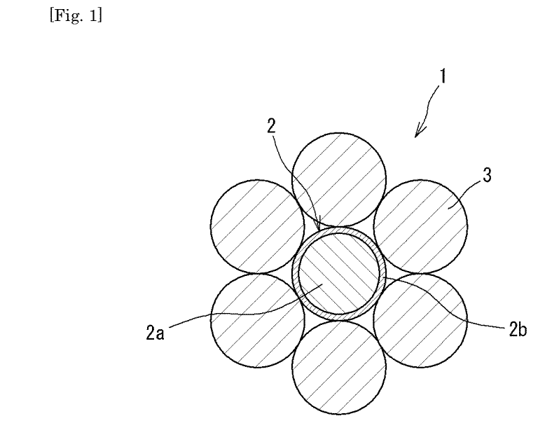

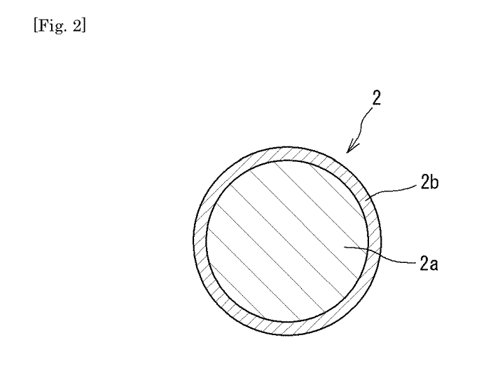

FIG. 1 is a schematic cross-sectional drawing which shows one embodiment of a composite twisted wire according to the present invention. FIG. 2 is a schematic cross-sectional drawing of an aluminum-covered wire which is used in the composite twisted wire of the present invention.

As shown in FIG. 1 and FIG. 2, the composite twisted wire 1 of the present invention includes an aluminum-covered wire 2 in which a layer 2b of aluminum or an aluminum alloy is formed on the surface of a steel wire 2a, and an aluminum wire 3 made of aluminum or an aluminum alloy.

The aluminum-covered wire 2 can be produced by forming a layer 2b of aluminum or an aluminum alloy on the surface of the steel wire 2a.

As a steel used in the steel wire 2a, there can be cited, for example, stainless steel, carbon steel and the like, and the present invention is not limited only to those exemplified ones.

The stainless steel is an alloy steel which contains 10% by mass or more of chromium (Cr). As the stainless steel, there can be cited, for example, austenitic steel, ferrite steel, martensitic steel and the like which are defined in JIS G4309, and the present invention is not limited only to those exemplified ones. Specific examples of the stainless steel include, stainless steel in which an austenite phase is usually thought to be metastable, such as SUS301 and SUS304; stable austenitic stainless steel such as SUS305, SUS310 and SUS316; ferrite stainless steel such as SUS405, SUS410, SUS429, SUS430, SUS434, SUS436, SUS444 and SUS447; martensitic stainless steel such as SUS403, SUS410, SUS416, SUS420, SUS431 and SUS440; chromium-nickel-manganese stainless steel which is classified in SUS200 series, and the like, and the present invention is not limited only to those exemplified ones.

The carbon steel is a steel which contains 0.02% by mass or more of carbon (C). As the carbon steel, there can be cited, for example, steel such as hard steel for wires prescribed in JIS G3560, soft steel for wires prescribed in JIS G3505, and the like, and the present invention is not limited only to those exemplified ones. Specific examples of the carbon steel include, hard steel, soft steel and the like, and the present invention is not limited only to those exemplified ones.

Among the above-mentioned steels, stainless steel and carbon steel are preferred from the viewpoint of improvement in tensile strength of the composite twisted wire 1 of the present invention.

The diameter of the steel wire 2a is not particularly limited, and it is preferred that the diameter is appropriately adjusted in accordance with uses of the composite twisted wire 1 of the present invention. When the composite twisted wire 1 of the present invention is used, for example, in uses such as a wire harness of an automobile, it is preferred that the diameter of the steel wire 2a is usually 0.05 to 0.5 mm or so.

A layer 2b of aluminum or an aluminum alloy is formed on the surface of the steel wire 2a. In the present invention, since the layer 2b of aluminum or an aluminum alloy is formed on the surface of the steel wire 2a as described above, the composite twisted wire 1 of the present invention is excellent in adhesion property between the aluminum-covered wire 2 and the aluminum wire 3, and also excellent in tensile strength and temporal stability of electric resistance.

The layer 2b can be formed only by aluminum, and may contain other element as occasion demands within a scope which would not hinder an object of the present invention.

As the above-mentioned other element, there can be cited, for example, nickel, chromium, zinc, silicon, copper, iron and the like, and the present invention is not limited only to those exemplified ones. When these other elements are incorporated in aluminum, mechanical strength of the layer 2b can be improved, and moreover tensile strength of the composite twisted wire 1 of the present invention can be improved. Among the other elements, although preferred one depends on the kind of the steel wire 2a, silicon is preferred from the viewpoint of suppression of generation of a brittle iron-aluminum alloy layer between iron contained in the steel wire 2a and aluminum contained in the layer 2b, and improvement in mechanical strength of the layer 2b.

The lower limit of the content of the other element in the layer 2b is 0% by mass. The content of the other element in the layer 2b is preferably 0.3% by mass or more, more preferably 0.5% by mass or more, and furthermore preferably 1% by mass or more, from the viewpoint of sufficient exhibition of properties based on the other element, and preferably 50% by mass or less, more preferably 20% by mass or less, and furthermore preferably 15% by mass or less, from the viewpoint of suppression of potential difference corrosion due to the contact of an aluminum wire.

As a method for forming the layer 2b of aluminum or an aluminum alloy on the surface of the steel wire 2a, there can be cited, for example, a method for plating a material for forming the layer 2b on the surface of the steel wire 2a and the like, and the present invention is not limited only to the exemplified one.

As a method for plating a material for forming the layer 2b on the surface of the steel wire 2a, there can be cite, for example, a hot-dip plating method, an electroplating method, a vacuum plating method and the like, and the present invention is not limited only to those exemplified ones. Among these methods, the hot-dip plating method is preferred from the viewpoint of formation of a layer having a uniform film thickness.

The thickness of the layer 2b is preferably 0.5 μm or more, and more preferably 3 μm or more, from the viewpoint of improvement in adhesion property between the aluminum-covered wire 2 and the aluminum wire 3, and is preferably 50 μm or less, and more preferably 30 μm or less, from the viewpoint of improvement in mechanical strength of the layer 2b.

Incidentally, in the composite twisted wire 1 of the present invention, a plated layer can be formed between the steel wire 2a and the layer 2b as an intermediate layer as occasion demands. As the metal for forming the plated layer, there can be cited, for example, zinc, nickel, chromium, alloy thereof and the like, and the present invention is not limited only to those exemplified ones. In addition, the plated layer can be only a single layer or plural plated layers made of the same metal or different metals. Also, the intermediate layer can be an alloy layer which is formed when the layer 2b is formed on the steel wire 2a according to the hot-dip plating method.

As described above, the aluminum-covered wire 2 is obtained by forming the layer 2b on the surface of the steel wire 2a. Incidentally, a stretching process can be conducted to the aluminum-covered wire 2 as occasion demands so that the aluminum-covered wire 2 has a desired wire diameter.

Since the aluminum wire 3 is used in the composite twisted wire 1 of the present invention, the weight of the composite twisted wire 1 can be reduced. In addition, since the aluminum-covered wire 2 is used together with the aluminum wire 3, the composite twisted wire 1 is excellent in tensile strength and temporal stability of electric resistance.

The aluminum wire 3 made of aluminum or an aluminum alloy can be a wire made of aluminum or a wire made of an aluminum alloy.

As the aluminum alloy, there can be cited, for example, aluminum-silicon alloy, aluminum-iron alloy, aluminum-chromium alloy, aluminum-nickel alloy, aluminum-zinc alloy, aluminum-copper alloy, aluminum-manganese alloy, aluminum-magnesium alloy (for example, Alloy No. A5056 defined in JIS H4040, and the like), aluminum-magnesium-silicon alloy, aluminum-zinc-magnesium alloy, aluminum-zinc-magnesium-copper alloy, and the like, and the present invention is not limited only to those exemplified ones. These aluminum alloys can be used alone or at least two kinds thereof can be used in combination.

The content of a metal other than aluminum in the aluminum alloy cannot be absolutely determined because the content differs depending on the kind of the metal. The content of the metal other than aluminum is usually preferably 0.3% by mass or more from the viewpoint of improvement in tensile strength, and is preferably 10% by mass or less from the viewpoint of reduction in weight and suppression of corrosion based on potential difference due to the contact with the aluminum-covered wire 2.

The metal which is used in the aluminum wire 3 made of aluminum or an aluminum alloy is preferably an aluminum alloy, and more preferably aluminum-manganese alloy and aluminum-magnesium-silicon alloy, from the viewpoint of improvement in tensile strength.

The diameter of the aluminum wire 3 is not particularly limited, and it is preferred that the diameter is appropriately adjusted in accordance with uses of the composite twisted wire 1 of the present invention. When the composite twisted wire 1 of the present invention is used, for example, in a wire harness of an automobile, the diameter of the aluminum wire 3 is usually preferably 0.05 to 0.5 mm or so.

The composite twisted wire 1 of the present invention can be produced by twisting the aluminum-covered wire 2 and the aluminum wire 3. Incidentally, the composite twisted wire 1 of the present invention may include a wire other than the aluminum-covered wire 2 and the aluminum wire 3 within a scope which would not hinder an object of the present invention.

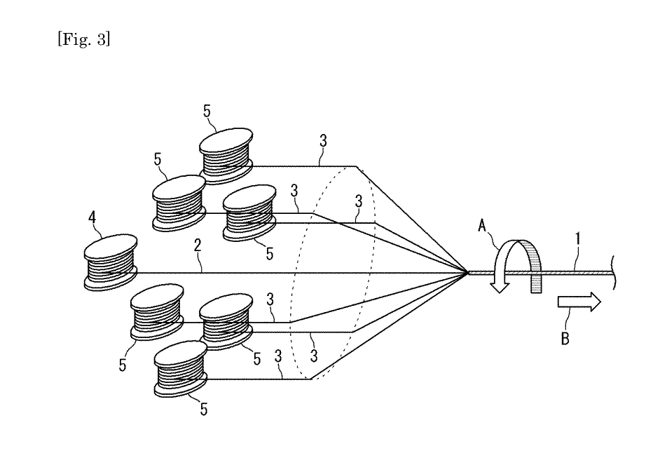

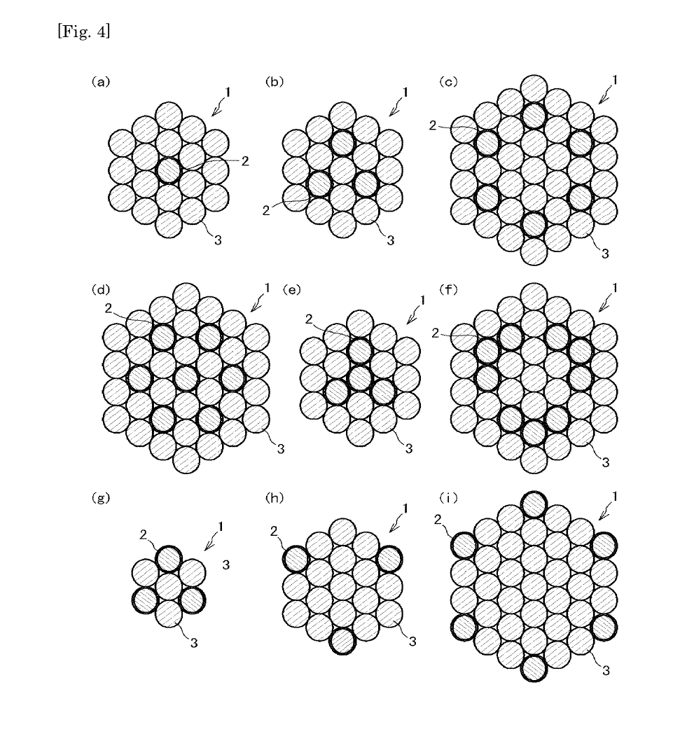

When the composite twisted wire 1 having a cross-sectional drawing shown in FIG. 1 is produced as the composite twisted wire 1 of the present invention, the composite twisted wire can be produced by, for example, a method shown in FIG. 3. FIG. 3 is a schematic explanatory drawing which shows one embodiment of a method for producing a composite twisted wire 1 according to the present invention.

As shown in FIG. 3, an aluminum-covered wire 2 is supplied from a supply bobbin 4, and an aluminum wire 3 is supplied from a supply bobbin 5.

According to the embodiment shown in FIG. 3, as a central wire which constitutes a central portion of the composite twisted wire 1 of the present invention, one aluminum-covered wire 2 is supplied from a supply bobbin 4. In addition, as the peripheral wires which surround the central wire, six aluminum wires 3 are fed from each supply bobbin 5, and supplied to the surrounding of the aluminum-covered wire 2. The composite twisted wire 1 can be produced by, for example, transferring the aluminum-covered wire 2 and the aluminum wires 3 to the direction of the arrow B while twisting the aluminum-covered wire 2 and the aluminum wires 3 in the direction of the arrow A.

The composite twisted wire 1 produced in the above has a cross-sectional shape shown in FIG. 1, and the present invention is not limited only to the above cross-sectional shape.

As a composite twisted wire having a cross-sectional shape other than the composite twisted wire shown in FIG. 1, there can be cited, for example, a composite twisted wire 1 having a cross-sectional shape shown in FIG. 4. In FIG. 4, each of figures (a) to (i) is a schematic cross-sectional drawing which shows other embodiment of the composite twisted wire of the present invention, respectively.

In FIG. 4, each of figures (a) to (d) shows a cross-section of a composite twisted wire 1 in which all of the wires positioning at the outermost periphery are aluminum wires 3, and each of the aluminum-covered wires 2 is contacted only with the aluminum wires 3.

In FIG. 4, each of figures (e) and (0 shows a cross-section of a composite twisted wire 1 in which all of the wires positioning at the outermost periphery are aluminum wires 3, and the aluminum-covered wires 2 are contacted with each other.

In addition, in FIG. 4, each of figures (g) to (i) shows a cross-section of a composite twisted wire 1 in which aluminum-covered wires 2 are positioned at the outermost periphery, and all of the aluminum-covered wires 2 are contacted only with the aluminum wire 3.

Among the embodiments shown in FIG. 4(a) to FIG. 4(i), it is preferred that the aluminum-covered wire 2 is contacted only with the aluminum wire 3 as shown in FIG. 4(a) to FIG. 4(d) from the viewpoint of improvement in adhesion of the composite twisted wire 1 of the present invention to a terminal (not shown) when the composite twisted wire 1 is crimped with the terminal, improvement in adhesion of the aluminum-covered wire 2 to the aluminum wire, and improvement in tensile strength of the composite twisted wire 1 of the present invention.

The number of the central wires which constitute a composite twisted wire 1 can be, for example, one as shown in FIG. 1, or can be plural, for example, 2 to 6 or so. The number of the central wires which constitute the composite twisted wire 1 is preferably one, three or seven, and more preferably one or three, from the viewpoint of improvement in tensile strength of the composite twisted wire 1 of the present invention. In addition, the central wire which constitutes the composite twisted wire 1 is preferably an aluminum-covered wire 2 from the viewpoint of improvement in tensile strength of the composite twisted wire 1 of the present invention. Therefore, from the viewpoint of improvement in tensile strength of the composite twisted wire 1 of the present invention, it is desired that the central wire which constitutes the composite twisted wire 1 is the aluminum-covered wire 2, and that the number of the central wires is one, three or seven, preferably one or three.

In the embodiment shown in FIG. 1, the number of the peripheral wires which surround the central wire is six. However, as shown in FIG. 4(a) to FIG. 4(i), the number of the peripheral wires can be plural, for example, 6 to 36 or so. From the viewpoint of improvement in tensile strength of the composite twisted wire 1 of the present invention, the number of the peripheral wires which constitute the composite twisted wire 1 is preferably 6 to 36, more preferably 6, 10, 12, 16 or 18, and furthermore preferably 6, 10 or 12, still furthermore preferably 6. In addition, it is preferred that the peripheral wire which constitutes the composite twisted wire 1 is the aluminum wire 3 from the viewpoint of improvement in tensile strength of the composite twisted wire 1 of the present invention.

Accordingly, it is preferred that the central wire is one aluminum-covered wire 2, and that the peripheral wires surrounding the central wire are six aluminum wires 3 as shown in FIG. 1, from the viewpoint of obtaining a composite twisted wire 1 which has a light weight, and is excellent in tensile strength and temporal stability of electric resistance.

As described above, the composite twisted wire 1 of the present invention has a light weight, and is excellent in tensile strength and temporal stability of electric resistance. The reason why the composite twisted wire 1 of the present invention is excellent in tensile strength and temporal stability of electric resistance is considered to be based on the following reasons:

That is, when a twisted wire made by twisting a steel wire and an aluminum wire is connected to a terminal by crimping, the steel wire is hardly deformed, and the aluminum wire softer than the steel wire is deformed at the crimping portion of the twisted wire and the terminal, to fill a gap in the terminal with the aluminum. Although the steel wire is held by the friction resistance between the steel wire and the aluminum wire, when the twisted wire is drawn out from the terminal under the above condition, a slip easily occurs between the steel wire and the aluminum wire, and the aluminum wire is hardly deformed. Therefore, it is thought that increase in friction resistance between the steel wire and the aluminum wire is low at the contact portion of the steel wire and the aluminum wire, and hence the steel wire is easily drawn out from the terminal.

To the contrary, in the composite twisted wire 1 of the present invention, the aluminum-covered wire 2 in which a layer 2b of aluminum or an aluminum alloy is formed on its surface is twisted together with the aluminum wire 3. When the composite twisted wire 1 is connected to a terminal by crimping, the steel wire 2a used in the aluminum-covered wire 2 is little deformed at the crimping portion of the composite twisted wire 1 and the terminal, and the layer 2b of aluminum or an aluminum alloy existing on the surface of the aluminum-covered wire 2 and the aluminum wire 3 are plastically deformed, to fill a gap in the terminal with the aluminum. When the composite twisted wire 1 is drawn out from the terminal under the above condition, a slip hardly occurs between the layer 2b of aluminum or an aluminum alloy existing on the surface of the aluminum-covered wire 2 and the aluminum wire 3, and a friction resistance increases. Therefore, it is thought that the steel wire 2a used in the aluminum-covered wire 2 is hardly drawn out from the terminal.

As explained above, since the aluminum-covered wire 2 and the aluminum wire 3 are used in the composite twisted wire 1 of the present invention as described above, the composite twisted wire 1 has a light weight, and is excellent in tensile strength and temporal stability of electric resistance, it is expected that the composite twisted wire 1 is employed in uses such as an electric wire which is used in, for example, a wire harness of an automobile and the like.

### EXAMPLES

Next, the present invention will be more specifically described in accordance with working examples, but the present invention is not limited only to those examples.

### Examples 1 to 8

As a steel wire, a steel wire having a wire diameter of 0.2 mm and a kind as shown in Table 1 was used. The steel wire was dipped in a molten aluminum bath (purity of aluminum: 99.7% or more), to form an aluminum layer having a thickness shown in Table 1, and the steel wire was stretched so as to have a wire diameter of 0.2 mm, to give an aluminum-covered wire. Incidentally, the thickness of the layer was determined by measuring a diameter of the aluminum-covered wire having an aluminum layer within a length of 100 mm at its five arbitrary positions and at an interval of 0.1 mm by means of an optical outer diameter measurement device (produced by KEYENCE CORPORATION under a product number of LS-7000), and the wire diameter (0.2 mm) before the formation of an aluminum layer was subtracted from the average of the measured diameters of the aluminum-covered wire.

The aluminum-covered wire obtained in the above was used as a central wire. As shown in FIG. 1, six aluminum wires made of aluminum alloy of A1070 having a wire diameter of 0.2 mm were used as peripheral wires and disposed on the central wire, and these wires were twisted at a twisting pitch of 12 mm, to give a composite twisted wire.

### Comparative Example 1

A composite twisted wire was produced in the same manner as in Example 1, except that a stainless steel wire made of stainless steel (SUS 304) having a wire diameter of 0.2 mm was directly used without plating as a central wire in place of the aluminum-covered wire used in Example 1.

Next, drawing or breaking of the central wire of the composite twisted wire obtained in each Example and Comparative Example 1 was examined in accordance with the following method. The results are shown in Table 1.

[Drawing or Breaking of Central wire of Composite Twisted Wire]

The composite twisted wire was disposed in a crimp terminal (produced by Nippon Tanshi Co., Ltd. under a product number of 17521-M2), and the crimp terminal was pressed so as to connect the composite twisted wire to the crimp terminal, to give a sample. A tensile test of the sample was carried out, and its result was used in evaluation of drawing or breaking of the central wire at the crimping portion.

Incidentally, breaking strength of each wire is as follows:

An aluminum-covered wire in which a stainless steel wire made of SUS304 is covered with aluminum: 38 N

An aluminum-covered wire in which a stainless steel wire made of SUS430 is covered with aluminum: 35 N

An aluminum wire made of aluminum alloy A1070: 9 N An aluminum wire made of aluminum alloy A5056: 14 N

Five samples obtained in the above were prepared. The crimp terminal of the sample was held by one chuck of a tensile testing machine (produced by Shimadzu Corporation under a commercial name of Auto Graph AG-5000B), and the central wire of the composite twisted wire was held by the other chuck thereof. Thereafter, a tensile test was carried out at a stretching speed of 10 mm/min until the central wire is broken or drawn out, and drawing of the central wire was evaluated in accordance with the following criteria of evaluation:

(Criteria of evaluation)

x: A central wire was drawn out.

∘: A central wire was broken without being drawn out

TABLE 1

| | Aluminum-covered wire | | | Kind of | |
|---|---|---|---|---|---|
| Example and | | Plated Layer | | Aluminum in | Drawing |
| Comparative | Kind of | | Thickness | Aluminum | or |
| Example No. | Steel | Kind | (μm) | Wire | Breaking |
| Example 1 | SUS304 | Al | 3 | A1070 | ◯ |
| Example 2 | SUS304 | Al | 5 | A1070 | ◯ |
| Example 3 | SUS304 | Al | 12 | A1070 | ◯ |
| Example 4 | SUS304 | Al | 17 | A1070 | ◯ |
| Example 5 | SUS304 | Al | 50 | A1070 | ◯ |
| Example 6 | SUS304 | Al | 55 | A1070 | ◯ |
| Example 7 | SUS316 | Al | 15 | A1070 | ◯ |
| Example 8 | SUS430 | Al | 15 | A1070 | ◯ |

| | | | | |
|---|---|---|---|---|
| Comparative | SUS304 | No Plated Layer | A1070 | X |
| Example 1 | | | | |

From the results shown in Table 1, it can be seen that the central wire of the composite twisted wire obtained in each Example is broken without being drawn out, as compared with the twisted wire obtained in Comparative Example 1.

Incidentally, the tensile strength of the central wire at break in the tensile test is substantially equal to the tensile strength of one aluminum-covered wire mentioned above. The same can be applied to the following Examples and Comparative Examples listed in Tables 2 to 6.

### Examples 9 to 11 and Comparative Example 2

A composite twisted wire was produced in the same manner as in Example 1, except that an aluminum-covered wire and an aluminum wire used in Example 1 were changed to those listed in Table 2, and drawing or breaking of a central wire of the composite twisted wire was examined in the same manner as in Example 1. The results are shown in Table 2.

TABLE 2

| | Aluminum-covered wire | | | Kind of | |
|---|---|---|---|---|---|
| Example and | | Plated Layer | | Aluminum in | Drawing |
| Comparative | Kind of | | Thickness | Aluminum | or |
| Example No. | Steel | Kind | (μm) | Wire | Breaking |
| Example 9 | SUS304 | Al | 5 | A5056 | ◯ |
| Example 10 | SUS304 | Al | 15 | A5056 | ◯ |
| Example 11 | SUS304 | Al | 50 | A5056 | ◯ |

| | | | | |
|---|---|---|---|---|
| Comparative | SUS304 | No Plated Layer | A5056 | X |
| Example 2 | | | | |

From the results shown in Table 2, it can be seen that the central wire of the composite twisted wire obtained in each Example is broken without being drawn out, as compared with the twisted wire obtained in Comparative Example 2.

### Examples 12 to 16 and Comparative Example 3

A composite twisted wire was produced in the same manner as in Example 1, except that the aluminum-covered wire used in Example 1 was changed to one listed in Table 3, and drawing or breaking of a central wire of the composite twisted wire was examined in the same manner as in Example 1. The results are shown in Table 3.

TABLE 3

| | Aluminum-covered wire | | | Kind of | |
|---|---|---|---|---|---|
| Example and | | Plated Layer | | Aluminum in | Drawing |
| Comparative | Kind of | | Thickness | Aluminum | or |
| Example No. | Steel | Kind | (μm) | Wire | Breaking |
| Example 12 | Hard Steel | Al | 3 | A1070 | ◯ |
| Example 13 | Hard Steel | Al | 5 | A1070 | ◯ |
| Example 14 | Hard Steel | Al | 10 | A1070 | ◯ |
| Example 15 | Hard Steel | Al | 20 | A1070 | ◯ |
| Example 16 | Hard Steel | Al | 50 | A1070 | ◯ |

| | | | | |
|---|---|---|---|---|
| Comparative | Hard Steel | No Plated Layer | A1070 | X |
| Example 3 | | | | |

(Note)
Hard Steel: Steel containing 0.37% by mass of carbon

From the results shown in Table 3, it can be seen that the central wire of the composite twisted wire obtained in each Example is broken without being drawn out, as compared with the twisted wire obtained in Comparative Example 3.

### Examples 17 to 21 and Comparative Example 4

A composite twisted wire was produced in the same manner as in Example 1, except that an aluminum-covered wire used in Example 1 was changed to one shown in Table 4, and drawing or breaking of a central wire of the composite twisted wire was examined in the same manner as in Example 1. The results are shown in Table 4.

TABLE 4

| | Aluminum-covered wire | | | Kind of | |
|---|---|---|---|---|---|
| Example and | | Plated Layer | | Aluminum in | Drawing |
| Comparative | Kind of | | Thickness | Aluminum | or |
| Example No. | Steel | Kind | (μm) | Wire | Breaking |
| Example 17 | Soft Steel | Al | 3 | A1070 | ◯ |
| Example 18 | Soft Steel | Al | 5 | A1070 | ◯ |
| Example 19 | Soft Steel | Al | 10 | A1070 | ◯ |
| Example 20 | Soft Steel | Al | 20 | A1070 | ◯ |
| Example 21 | Soft Steel | Al | 50 | A1070 | ◯ |

| | | | | |
|---|---|---|---|---|
| Comparative | Soft Steel | No Plated Layer | A1070 | X |
| Example 4 | | | | |

(Note)
Soft Steel: Steel containing 0.10% by mass of carbon

From the results shown in Table 4, it can be seen that the central wire of the composite twisted wire obtained in each Example is broken without being drawn out, as compared with the twisted wire obtained in Comparative Example 4.

### Examples 22 to 24 and Comparative Example 5

A composite twisted wire was produced in the same manner as in Example 1, except that an aluminum-covered wire and an aluminum wire used in Example 1 were changed to those listed in Table 5, and drawing or breaking of a central wire was examined in the same manner as in Example 1. The results are shown in Table 5.

TABLE 5

| | Aluminum-covered wire | | | Kind of | |
|---|---|---|---|---|---|
| Example and | | Plated Layer | | Aluminum in | Drawing |
| Comparative | Kind of | | Thickness | Aluminum | or |
| Example No. | Steel | Kind | (μm) | Wire | Breaking |
| Example 22 | Hard Steel | Al | 5 | A5056 | ◯ |
| Example 23 | Hard Steel | Al | 15 | A5056 | ◯ |
| Example 24 | Hard Steel | Al | 50 | A5056 | ◯ |

| | | | | |
|---|---|---|---|---|
| Comparative | Hard Steel | Without | A5056 | X |
| Example 5 | | Plated Layer | | |

(Note)
Hard Steel: Steel containing 0.37% by mass of carbon

From the results shown in Table 5, it can be seen that the central wire of the composite twisted wire obtained in each Example is broken without being drawn out, as compared with the twisted wire obtained in Comparative Example 5.

### Examples 25 to 33

A composite twisted wire was produced, and drawing or breaking of a central wire was examined in the same manner as in Example 1, except that molten aluminum used in Example 1 was changed to one shown in Table 6, and that the thickness of a plated layer was changed to 12 μm. The results are shown in Table 6.

TABLE 6

| | Aluminum-covered wire | | | Kind of | |
|---|---|---|---|---|---|
| Example and | | Plated Layer | | Aluminum in | Drawing |
| Comparative | Kind of | | Thickness | Aluminum | or |
| Example No. | Steel | Kind | (μm) | Wire | Breaking |
| Example 25 | SUS304 | Al containing | 12 | A1070 | ◯ |
| | | 0.5% by mass | | | |
| | | of Si | | | |
| Example 26 | SUS304 | Al containing | 12 | A1070 | ◯ |
| | | 2.5% by mass | | | |
| | | of Si | | | |
| Example 27 | SUS304 | Al containing | 12 | A1070 | ◯ |
| | | 9.0% by mass | | | |
| | | of Si | | | |
| Example 28 | SUS304 | Al containing | 12 | A1070 | ◯ |
| | | 0.2% by mass | | | |
| | | of Fe | | | |
| Example 29 | SUS304 | Al containing | 12 | A1070 | ◯ |
| | | 2.0% by mass | | | |
| | | of Fe | | | |
| Example 30 | SUS304 | Al containing | 12 | A1070 | ◯ |
| | | 0.1% by mass | | | |
| | | of Cr | | | |
| Example 31 | SUS304 | Al containing | 12 | A1070 | ◯ |
| | | 0.1% by mass | | | |
| | | of Ni | | | |
| Example 32 | SUS304 | Al containing | 12 | A1070 | ◯ |
| | | 0.1% by mass | | | |
| | | of Zn | | | |
| Example 33 | SUS304 | Al containing | 12 | A1070 | ◯ |
| | | 1.0% by mass | | | |
| | | of Zn | | | |

From the results shown in Table 6, it can be seen that the central wire of the composite twisted wire obtained in each Example is broken without being drawn out. In addition, from the results shown in Table 1 and Table 6, it can be seen that the central wire of the composite twisted wire is broken without being drawn out, even when 1% by mass or more of silicon, iron, chromium, nickel or zinc is contained in the plated layer.

### Example 34

A stainless steel wire made of stainless steel (SUS304) having a wire diameter of 0.2 mm was used as a steel wire. The stainless steel wire was dipped in a molten aluminum bath (purity of aluminum: 99.7% or more), to form an aluminum layer having an average thickness of 8 μm, and then the stainless steel wire was stretched so as to have a wire diameter of 0.2 mm, to give an aluminum-covered wire. Incidentally, the thickness of the layer was determined in the same manner as in Example 1.

Next, the aluminum-covered wire obtained in the above was used as a central wire, and six aluminum wires made of aluminum (A1070) having a wire diameter of 0.2 mm were disposed on the surface of the aluminum-covered wire as peripheral wires. These wires were twisted at a twisting pitch of 12 mm, to give a composite twisted wire.

### Comparative Example 6

A stainless steel wire made of stainless steel (SUS304) having a wire diameter of 0.2 mm was used as a steel wire. The steel wire was dipped in a molten zinc bath, to form a zinc layer having a thickness of 3 μm, and then the steel wire was stretched so as to have a wire diameter of 0.2 mm, to give a zinc-covered wire. Incidentally, the thickness of the layer was determined in the same manner as in Example 1.

Next, the zinc-covered wire obtained in the above was used as a central wire, and six aluminum wires made of aluminum (A1070) having a wire diameter of 0.2 mm were disposed on the surface of the zinc-covered wire as peripheral wires. These wires were twisted at a twisting pitch of 12 mm, to give a composite twisted wire.

### Comparative Example 7

A stainless steel wire made of stainless steel (SUS304) having a wire diameter of 0.22 mm was used as a central wire, and six aluminum wires made of aluminum (A1070) having a wire diameter of 0.2 mm were disposed on the surface of the central wire as peripheral wires. These wires were twisted at a twisting pitch of 12 mm, to give a composite twisted wire.

### Comparative Example 8

An aluminum wire made of aluminum (A1070) having a wire diameter of 0.2 mm was used as a central wire, and six aluminum wires made of aluminum (A1070) having a wire diameter of 0.2 mm were disposed on the surface of the central wire as peripheral wires. These wires were twisted at a twisting pitch of 12 mm, to give a twisted wire.

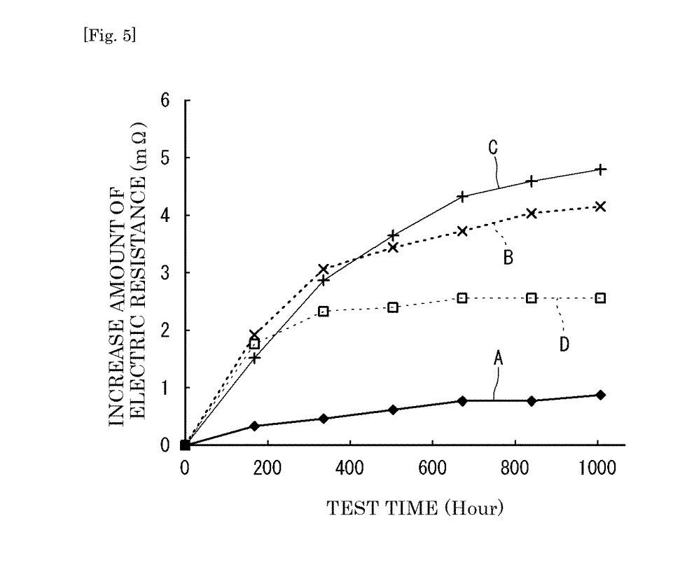

The twisted wires obtained in the above were used for examining temporal stability of electric resistance in accordance with the following method. The results are shown in FIG. 5.

Incidentally, in FIG. 5, “A” denotes a measurement result of temporal stability of electric resistance of the composite twisted wire obtained in Example 34, “B” denotes a measurement result of temporal stability of electric resistance of the composite twisted wire obtained in Comparative Example 6, “C” denotes a measurement result of temporal stability of electric resistance of the composite twisted wire obtained in Comparative Example 7, and “D” denotes a measurement result of temporal stability of electric resistance of the twisted wire obtained in Comparative Example 8.

(Temporal Stability of Electric Resistance)

A twisted wire was covered with polypropylene, and cut into a length of 15 cm. Each end of the twisted wire was crimped with a terminal [a terminal made of brass having a thickness of 0.2 mm on which tin plating was carried out, which is a commercially available male terminal for connecting an in-vehicle signal line, called as 0.64 (025)], respectively, to give a sample.

Each of four kinds of the samples obtained in the above was prepared as five sets, and an environment test was carried out for each sample for 1000 hours in an atmosphere having a relative humidity of 98% or more and a temperature of 50° C. by means of an environment testing machine. During the test, the sample was taken out from the environment testing machine when an arbitrary time passed, and a current of 1 mA was applied to the sample by means of a constant current generation device, to determine a voltage between both ends of the terminal. From the measurement result, change of electric resistance with the passage of time was examined. Incidentally, the electric resistance between both ends of the terminal before the test was within a range of 19 to 22 mΩ in any of the samples.

From the results shown in FIG. 5, it can be seen that the composite twisted wire obtained in Example 34 (“A” in FIG. 5) is excellent in temporal stability of electric resistance, because change of electric resistance of the composite twisted wire with the passage of time is smaller than the composite twisted wire obtained in Comparative Example 6 in which the layer is contacted with an aluminum wire of which metal is dissimilar to the metal of the layer (“B” in FIG. 5) and the composite twisted wire obtained in Comparative Example 7 (“C” in FIG. 5). In particular, it is characteristic in functions and effects exhibited by the composite twisted wire of the present invention that the composite twisted wire obtained in Example 34 (“A” in FIG. 5) is more excellent in temporal stability of electric resistance than the twisted wire obtained in Comparative Example 8 (“D” in FIG. 5), that is, a twisted wire in which both central wire and peripheral wire are made of an aluminum alloy.

It is thought that its reason is based on that since internal stress of aluminum easily decreases when a twisted wire formed from aluminum wires is crimped with a terminal, a gap between the terminal and the wire made of aluminum is easily generated, resulting in gradual increase of electric resistance, formation of an oxide film on the surface of the aluminum wire and increase of electric resistance with the passage of time. To the contrary, since the composite twisted wire of the present invention includes a wire made of a steel wire having a surface on which an aluminum layer is formed, it is thought that this steel wire suppresses lowering of internal stress at the crimping portion, and hence increase in electric resistance with the passage of time is suppressed.

Next, each composite twisted wire obtained in each of Comparative Example 7 and Example 34 was cut at the crimping portion of the composite twisted wire and the terminal, and its cross-section was observed.

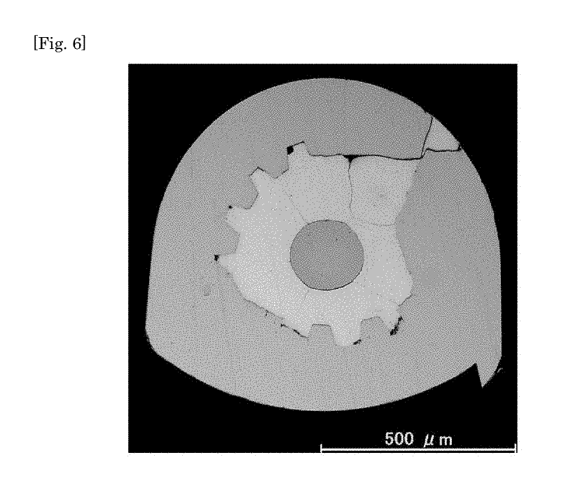

FIG. 6 is an optical microscope photograph of a cross-section of a crimping portion of a sample obtained by crimping the composite twisted wire obtained in Comparative Example 7 with a terminal.

As shown in FIG. 6, one stainless steel wire made of stainless steel (SUS304) is positioned at a center, and six aluminum wires made of aluminum (A1070) are positioned on the surface of the stainless steel wire. Furthermore, these wires are surrounded by a terminal. In the wires, since one steel wire and six aluminum wires are crimped by the terminal, it can be seen that the aluminum wire is plastically deformed to fill a gap in the terminal, and that a distinct boundary between the steel wire and the aluminum wire is existing.

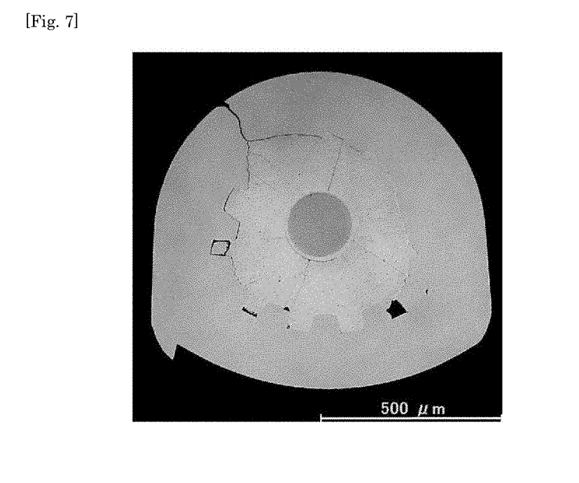

On the other hand, FIG. 7 is an optical microscope photograph of a crimping portion of a sample obtained by crimping the composite twisted wire obtained in Example 34 with a terminal.

As shown in FIG. 7, the central wire is one aluminum-covered wire obtained by forming an aluminum layer having an average thickness of 8 μm on a stainless steel wire made of stainless steel (SUS304), and six aluminum wires made of aluminum (A1070) are positioned on the surface of the aluminum-covered wire as peripheral wires. Furthermore, these wires are surrounded by a terminal. Since the composite twisted wire obtained in Example 34 has an aluminum layer on the surface of the central steel wire, and this aluminum layer is unified into one body together with the aluminum wire, it can be seen that a distinct boundary of both is existing.

Therefore, according to the composite twisted wire obtained in Example 34, since a portion in which the aluminum layer and the aluminum wire is unified into one body exists, it can be seen that a slip between a layer made of aluminum or an aluminum alloy existing on the surface of the aluminum-covered wire and an aluminum wire hardly occurs when the composite twisted wire is drawn out from a terminal, friction resistance increases, and thereby the steel wire used in the aluminum-covered wire is hardly drawn out from the terminal. As mentioned above, according to the composite twisted wire obtained in Example 34, since the aluminum layer and the aluminum wire are unified into one body, it is thought that the composite twisted wire of the present invention exhibits excellent effects such as excellent temporal stability of electric resistance as shown in FIG. 5.

### INDUSTRIAL APPLICABILITY

The composite twisted wire of the present invention has a light weight, and is excellent in temporal stability of electric resistance. Therefore, the composite twisted wire can be suitably used in, for example, a wire harness of an automobile, and the like.

### EXPLANATIONS OF NUMERALS

1: composite twisted wire
2: aluminum-covered wire
2a: steel wire
2b: layer
3: aluminum wire
4: supply bobbin
5: supply bobbin

1-4. (canceled)

5. A composite twisted wire in which plural wires are twisted, comprising:
(a) plural aluminum-covered wires each of which has a circular shape along a cross section of the composite twisted wire, and
(b) plural aluminum wires each of which has a circular shape along the cross section of the composite twisted wire,
wherein each of the aluminum covered wires is made of a steel wire and a surface layer, in which the surface layer is made of aluminum or aluminum alloy;
wherein each of the aluminum wires is made of aluminum or an aluminum alloy;
wherein the aluminum wires are positioned at the outmost surface of the composite twisted wire; and
wherein each of the aluminum-covered wires is in contact with only aluminum wires.

6. The composite twisted wire according to claim 5, wherein the steel of the steel wire used in the aluminum-covered wire is carbon steel or stainless steel.

7. The composite twisted wire according to claim 5, wherein the steel of the steel wire used in the aluminum-covered wire is stainless steel.

8. The composite twisted wire according to any one of claim 5, wherein the surface layer is made of an aluminum containing at least one element selected from the group consisting of nickel, chromium, zinc, silicon, copper, and iron in a content of 0.3% by mass to 50% by mass.

9. The composite twisted wire according to claim 5, wherein the surface layer has a thickness of from 0.5 μm to 50 μm.
